(19) United States
(12) Patent Application Publication
(10) Pub. No.: US 2013/0104149 A1
(43) Pub. Date: Apr. 25, 2013

(54) SELECTIVE DATA PROCESSING METHOD BETWEEN DOCKED TERMINALS AND SELECTIVE DATA PROCESSING SYSTEM USING THE SAME

(71) Applicants: Byeong-Nam AHN, Seong nam (KR); Syeung-il KIM, Seong nam (KR); Young-Mook CHO, Seong nam (KR)

(72) Inventors: Byeong-Nam AHN, Seong nam (KR); Syeung-il KIM, Seong nam (KR); Young-Mook CHO, Seong nam (KR)

(73) Assignee: HANDONG LNC CO., LTD., Seongnam-si (KR)

(21) Appl. No.: 13/281,398

(22) Filed: Oct. 25, 2011

(51) Int. Cl. G06F 9/44

(52) U.S. Cl. 719/324

(57) ABSTRACT

A selective data processing method between docked terminals, and a selective data processing system using the same are provided. The selective data processing method includes generating a virtual driver, transmitting a first data generated from a device of a first terminal, transmitting a second data generated from a device of a second terminal to a virtual driver and selecting at least one of the first data and the second data, and transmitting the selected at least one of the first data and the second data to an upper layer of layers where the same driver and the virtual driver reside, and enabling the transmitted at least one of the first data and the second data to be processed.

### BACKGROUND OF THE INVENTION

1. Field of the Invention

Methods and apparatuses consistent with the exemplary embodiments relate to a selective data processing method between docked terminals and selective data processing system using the same, and more particularly, to a selective data processing method between docked terminals wherein one terminal of the docked terminals selectively process data received from both docked terminals, and a selective data processing system using the same.

2. Description of the Prior Art

Due to the recent remarkable development of communications technology and popularization of smart phones, a lot of people have smart phones nowadays not merely for telephoning purposes but also for various purposes such as entertainment, writing documents, trading stocks, playing multimedia, and maintaining social relationships etc.

However, a smart phone is equipped with a limited interface device, unlike those used in computers such as mass storage devices, backup devices, and local printers. Moreover, since smart phones are designed with priority consideration given to portability, it is true that the size of display is limited and that the size of buttons and items on a screen is small, making it difficult for a user to manipulate the device quickly and easily.

Therefore, in reality most of the smart phone users perform necessary operations or work through a separate device such as a desktop, notebook, and laptop when they are at home, and use their smart phones only in situations where they cannot use a separate device.

However, if a user is to use an application or environment that he/she used in a smart phone in a separate device once again, there is inconvenience of having to transfer the data stored in the smart phone to the separate device.

In order to increase convenience when using a smart phone which has limited interface device, a docking station for providing an additional input/output interface device is used. When using the docking station, the user is able to use an extension slot, external memory device, dialogue surface display, keyboard, mouse, and local printer, which increases efficiency of operations or work. Furthermore, since the user could use the application and environment that he/she used in the smart phone, the operations or work can be continued.

However, in order for the docking system to work properly, there must not be any collision between the two terminals. For example, supposing a smart phone is docked on a smart pad, in the case where the smart phone and the smart pad both have illuminance sensors and each of them operates, there comes a problem of not being able to obtain the adequate backlight values perceived by the smart phone and smart pad due to difference of illuminance values obtained by the smart phone and smart pad.

In order to prevent this problem, if a smart phone and smart pad have the same device like the illuminance sensor, it is possible to consider turning off the operation of one of the devices or disregarding the data obtained from one of the devices.

However, if only the data from either one of the devices is obtained, there comes a problem where the other device is not utilized properly just because the devices are docked.

This problem deteriorates in the case where the devices provided in each terminal are the same but have different specifications or structures. For example, in the case where the resolution of a camera module of the smart phone is 5 million pixel and the resolution of a camera module of the smart pad is 1 million pixel, it is not efficient to use only the camera module of the smart pad. Furthermore, since the camera module of the smart phone and the camera module of the smart pad are located in different places, the images obtained from the smart phone and the smart pad may be different from each other, making it difficult to obtain the image that the user wants.

Therefore, instead of collecting data from just one particular terminal and processing it, there is a need to seek a method to selectively collect and use the data from both docked terminals depending on circumstances.

### SUMMARY OF THE INVENTION

An aspect of the exemplary embodiments relates to a selective data processing method between docked terminals wherein one terminal of the docked terminals selectively process data received from both docked terminals, and a selective data processing system using the same.

According to an exemplary embodiment of the present disclosure, a method for selectively processing data received from devices of a first terminal and devices of a second terminal, wherein the first terminal is docked on the second terminal, may include generating, in the first terminal, a virtual driver regarding a device provided in the second terminal; transmitting a first data generated from the device of the first terminal to a driver of the device provided in the first terminal which is the same as the device provided in the second terminal, of drivers of the devices provided in the first terminal; receiving a second data generated from the device of the second terminal, and transmitting the received second data to the virtual driver; and selecting at least one of the first data and the second data, transmitting the selected at least one of the first data and the second data to an upper layer of layers where the same driver and the virtual driver reside, and enabling the transmitted at least one of the first data and the second data to be processed.

The selective data processing method may further include generating a wrapper driver which receives the first data from the same driver, and receives the second data from the virtual driver, wherein the enabling the transmitted at least one of the first data and the second data to be processed may have the wrapper driver transmit the at least one of the first data and the second data to the upper layer according to a setting, and enable the transmitted at least first data and the second data to be processed.

The transmitting the received second data to the virtual driver may include the second terminal adding header information per device to the second data and transmitting the second data where the header information is added to the virtual driver, and if the device according to the header information is differentiable in the second data received from the second terminal, the first terminal may directly transmit the second data to the virtual driver; but if the device according to the header information is not differentiable in the second data, the first terminal may transmit the second data to the virtual driver via an event machine which manages events occurring when connecting the first terminal and the second terminal.

The event machine may analyze the device where the second data can be processed, and transmit the second data to a virtual driver which corresponds to the analyzed device of the virtual drivers.

The header information may include information on the device where the second data can be processed of the devices of the second terminal, and be added by an event controller which manages the events occurring when connecting the first terminal and the second terminal.

The event controller and the event machine may reside in an upper layer of layers where the same driver and the virtual driver reside, if the first terminal and the second terminal operate based on OS; and exist in one code within the firmware, if the first terminal and the second terminal operate based on firmware.

The setting may be different per device, and thus one of the first data and the second data may be transmitted to the upper layer, or an average of the first data and the second data may be transmitted to the upper layer, or a sum of weighted values of the first data and the second data may be transmitted to the upper layer.

The first data and the second data may be received from the device driver of the first terminal and the device driver of the second terminal according to a service command of the upper driver.

According to an exemplary embodiment of the present disclosure, a system for selectively processing data received from a device of a first terminal and a device of a second terminal, wherein the first terminal is docked on the second terminal, wherein the system generates a virtual driver regarding a device provided in the second terminal, the system may include a first terminal which transmits a first data generated from the device of the first terminal to a driver of the device provided in the first terminal which is the same as the device provided in the second terminal, of drivers of the devices provided in the first terminal, receiving a second data generated from the device of the second terminal and transmitting the received second data to the virtual driver, and selecting at least one of the first data and the second data, and transmitting the selected at least one of the first data and the second data to an upper layer of layers where the same driver and the virtual driver reside and enabling the transmitted at least one of the first data and the second data to be processed; and a second terminal which generates a second data and transmits the generated second data to the first terminal.

The aforementioned enables selective utilization of data collected from devices of the two terminals even when the two terminals are docked on each other, increasing efficiency of using the two docked terminals.

### BRIEF DESCRIPTION OF THE DRAWINGS

The above and/or other aspects of the present disclosure will be more apparent by describing certain present disclosure with reference to the accompanying drawings, in which:

FIGS. 1 and 2 are views illustrating a docking system where the present disclosure is applicable;

FIG. 3 is a block diagram of the aforementioned docking system;

FIG. 4 is a view partially illustrating an architecture layer under an android platform, as one of application systems which can be used in a smart phone and a smart pad;

FIG. 5 is a flowchart provided to explain a preparation process in the smart phone for collecting data from the smart pad;

FIG. 6 is a flowchart provided to explain a selective data processing method according to an exemplary embodiment of the present disclosure;

FIG. 7 is a view provided to explain a pre-processing procedure of the data collected from the smart pad; and

FIG. 8 is a view provided to explain a procedure of processing the data collected from the smart phone and from the smart pad.

### DETAILED DESCRIPTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

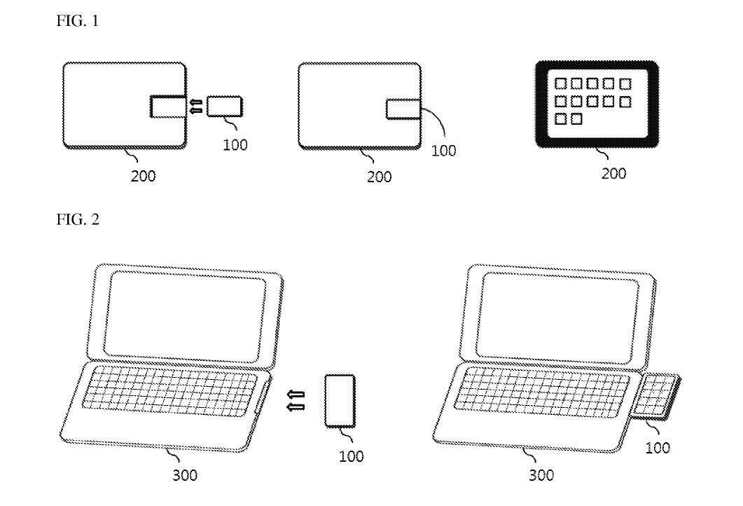

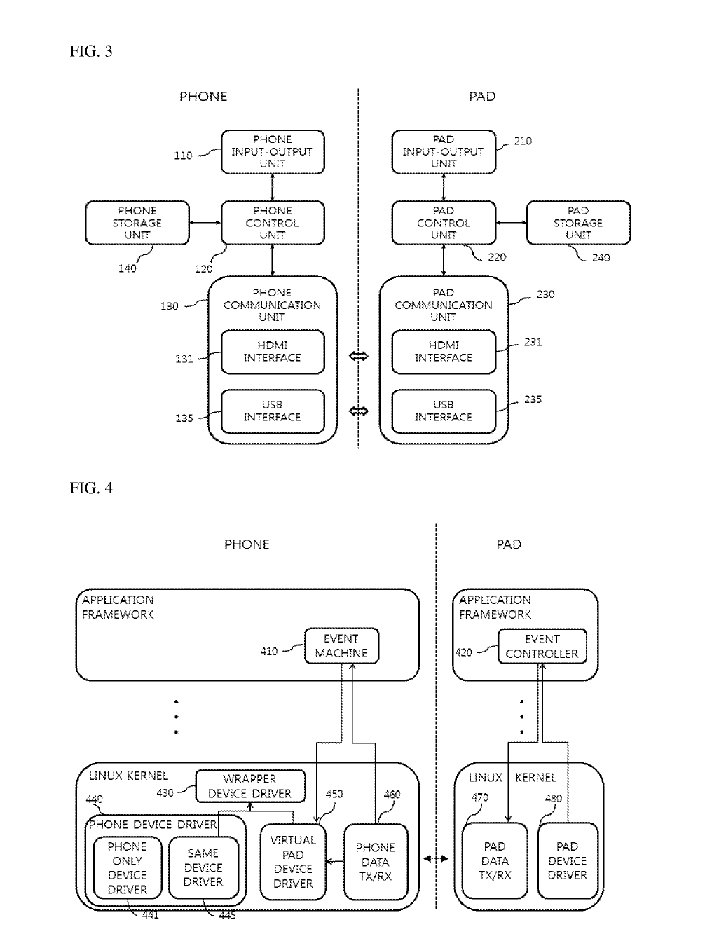

FIGS. 1 and 2 are views illustrating a docking system where the present invention is applicable.

First of all, FIG. 1 is a view illustrating the docking system for interlocking between a smart phone 100 and a smart pad 200. The smart phone 100 and the smart pad 200 may each be operated by separate operation systems, may drive separate application programs, and are equipped with separate devices. Of course, such operation systems and applications may be the same, similar, or different from each other, just as their provided devices may be the same, similar or different from each other.

For example, the smart phone 100 may be operated by an android operation system and drive application programs A, B, and C, while the smart pad 200 is operated by the same android operating system, but drive application programs B, C, and D. Similarly, the smart phone 100 may be equipped with a communications module for phone-calling and a camera module for photo-graphing, while the smart pad 200 is equipped with the same communications module for phone-calling, but also a camera module having higher specifications.

The present disclosure provides a method to selectively utilize and process the data collected from the devices of both terminals, since even when the terminals have the same devices, different data can be collected through each device since the devices have different specifications, arrangements or structures as mentioned above.

Since the smart phone 100 and the smart pad 200 are equipped with separate operating systems and thus operate according to separate operating systems, if they are not docked to each other as in the first illustration in FIG. 1, they are operated separately by their own operation systems.

However, in the smart phone 100 and the smart pad 200 according to the present disclosure, the smart phone 100 can be docked on a docking station located in a rear surface of the smart pad 200 as illustrated in the second illustration in FIG. 1. Of course, since the docking station is located in the rear surface of the smart pad 200, when using the smart pad 200 with the smart phone 100 docked on the smart pad 200, in order to prevent any input by error manipulation of the smart phone 100, the docking should be done in such a manner that a front surface of the smart phone 100 is not exposed, as in the second illustration in FIG. 1.

In addition, since the smart phone 100 is docked on the docking station located in the rear surface of the smart pad 200, if the docked system is used in its laid state, most of the devices except for those located in the side of the smart phone 100 may not be used.

That is, the data collected from the devices of the smart phone 100 and the smart pad 200 may or may not be used selectively depending on what kind of dummy terminal the smart phone 100 is docked on.

The third illustration in FIG. 1 is a screen which is operated by the operating system in the smart phone 100, or operated by the application program installed in the smart phone 100, after the smart phone 100 and the smart pad 200 are docked to each other.

As mentioned above, in the case of docking the smart phone 100 and the smart pad 200 and thereby interlocking the usage of the two terminals, a user is able to continue any operation or work that he/she used to do in the smart phone 100. Not only that, the user is able to use devices such as a display or a high-power speaker of the smart pad 200, which is an advantage of the smart pad 200, improving convenience of the user's operations or work.

Next, FIG. 2 illustrates a docking system for interlocking usage between the smart phone 100 and a laptop 300. The main difference of FIG. 1 from FIG. 2 is that in the docking system of FIG. 2, the smart phone 100 is not docked to be completely inserted into the docking system but is inserted partially into the docking station, enabling the smart phone 100 to function as a number pad for the laptop 300.

Therefore, unlike in FIG. 1, the smart phone 100 is docked on the laptop 300 in such a manner that a display of the smart phone 100 is exposed.

In this case, since a front surface unit of the smart phone 100 is exposed, most of the data collected from the devices located in the front surface unit of the smart phone 100 can be collected.

For example, in the case where data is collected through an illuminance sensor and the illuminance sensor is located in the front surface unit of the smart phone 100, in adjusting the lightness of a backlight, it may be possible to select either the data collected from the illuminance sensor of the smart phone 100 or the data collected from the illuminance sensor of the laptop 300, or use the average value of the two data, or use the sum of the two data multiplied by the weighted value of each data.

In addition, in the case of collecting image data through a camera module and the camera module is located in the front surface unit of the smart phone 100, in displaying image data on a display of the laptop 300, it may be possible to select either the image data collected from the camera module of the smart phone 100 or the image data collected from the camera module of the laptop 300 and display on the display of the laptop 300, or display overlapped image data of the two image data on the display of the laptop 300, or display divided image of the two image data on the display of the laptop 300.

Also by the aforementioned method, in the case of docking the smart phone 100 and the laptop 300 and thereby interlocking the usage of the two terminals, the user becomes able to continue any operation or work that he/she used to do in the smart phone 100 in the laptop 300. Not only that, the user can make use of the advantages of the laptop 300 as well.

Meanwhile, although in FIG. 2 the smart phone 100 is used as the number pad for the laptop 300, this is only an example for the convenience of explaining the present disclosure, and thus the technical concept of the present disclosure can also be applied when the smart phone 100 is used as a general touch pad instead of the number pad.

In addition, although in FIGS. 1 and 2, the smart phone 100 is docked on the smart pad 200 and the laptop 300, respectively, this is also only examples for convenience of explaining the present disclosure, and thus so long as separate terminals are docked to each other, such as the smart pad 200 and the laptop 300 being docked to each other or the smart phone 100 and a desktop (not illustrated) being docked to each other, these are all regarded to be within the scope of applying the present disclosure.

Furthermore, the docking locations or methods of the aforementioned smart phone 100 are also mere examples for the convenience of explaining the present disclosure, and thus the present disclosure could also be applied to cases of dockings by other methods and in locations not illustrated herein.

FIG. 3 is a block diagram of the aforementioned docking system. Hereinafter for convenience of explaining the present disclosure, the supposition will be that the smart phone 100 and the smart pad 200 are docked and interlocked to each other.

The smart phone 100 comprises a phone input-output unit 110, a phone control unit 120, a phone communication unit 130 and a phone storage unit 140.

The phone input-output unit 110 is used for the purpose of receiving signals input from a user or an external server or a terminal such as a touch screen, a button, and a speaker, and displaying the received signals on a screen or outputting them as voice.

The phone control unit 120 controls the phone input-output unit 110, the phone communication unit 130, and the storage unit 140 in such manners that the smart phone 100 can perform its functions properly. Especially, the phone control unit 120 controls the phone input-output unit 110 to process signals or user inputs received, and to display or output the processed results through the phone input-output unit 110. In addition, the phone control unit 120 controls the phone communication unit 130 to enable information exchange and data transmission and reception between the smart phone 100 and the smart pad 200. Not only that, the phone control unit 120 controls the phone storage unit 140 to store data transmitted to the phone input-output unit 100 and data transmitted and received through the phone communication unit 130, or to display data stored in the phone storage unit 140 through the phone input-output unit 110 or to transmit data to the smart pad 200.

Furthermore, the phone control unit 120 controls so that the smart phone 100 is implemented according to an operating system or an application program stored in the phone storage unit 140.

In addition, the phone control unit 120 controls each device of the smart pad 200 to operate according to the operating system or the application program implemented in the smart phone 100, in the case where the smart phone 100 is docked on the smart pad 200.

For example, in the case where the smart phone 100 is docked on the smart pad 200, the phone control unit 120 controls the phone input-output unit 110 to be inactivated, that the input-output data is transmitted to the smart pad 200 through the phone communication unit 140 and is input-output in the smart pad 200.

Under the control of the phone control unit 120, the phone communication unit 130 operates as a means to communicate with the smart pad 200 or an external terminal. Especially, the phone communication unit 130 is equipped with an HDMI interface 131 and a USB interface 135, so as to transmit/receive data and signals by communicating with the smart pad 200.

The phone storage unit 150 stores operating systems or application programs for driving the smart phone 100.

As aforementioned, through the HDMI interface 131 and USB interface 135 provided in the phone communication unit 130, the smart phone 100 enables screens or voices generated in the smart phone 100 to be displayed or output in the smart pad 200.

Meanwhile, the smart pad 200 comprises a pad input-output unit 210, a pad control unit 220, a pad communication unit 230, and a pad storage unit 240.

Hereinafter the explanation will be focusing on the operations in the case where the smart phone 100 is docked on the smart pad 200.

The pad control unit 220 controls the pad communication unit 230 to enable information exchange and data transmitting/receiving between the smart phone 100 and the smart pad 200. Not only that, the pad control unit 220 controls the pad storage unit 240 to store data received from the smart phone 100 through the pad communication unit 240 or to transmit data stored in the pad storage unit 240 to the smart phone 100.

In the case where the smart phone 100 is docked on the smart pad 200, the pad control unit 220 controls each device of the smart pad 200 to operate according to operating systems and application programs implemented in the smart phone 100.

When the smart pad 200 is not interlocked to the smart phone 100, the smart pad 200 is operated by its separate operating system, but when the smart pad 200 is interlocked to the smart phone 100, the smart pad 200 receives data regarding the operations by the operating system of the smart phone 100 from the smart phone 100 through the pad communication unit 230 and provides the data to the user.

FIG. 4 partially illustrates an architecture layer under an android platform, which is one of the application systems that can be used in the smart phone 100 and the smart pad 200. The android operating system is stored in the phone storage unit 140 of the smart phone 100 and the pad storage unit 240 of the smart pad 200, enabling the smart phone 100 and the smart pad 200 to operate according to the android operating system stored in the smart phone 100 and the smart pad 200.

The android platform refers to a software package which includes a Linux Kernel, HAL (Hardware Abstraction Layer), Library, application framework, and application, and hereinafter, the explanation will focus on the application framework layer and the Linux Kernel layer which are necessary portions in understanding the present disclosure.

The application framework layer is a layer just below the uppermost layer, the application layer. In the application framework layer, there are various controllers in demon forms and the controllers manage the operating system. Especially in such an application framework, there is an event machine 410 or an event controller 420.

The event machine 410 which operates in the application framework layer of the smart phone 100 manages a wrapper device driver 430 which will be explained in detail hereinafter and performs the role of managing the events that occur in the smart phone 100 when the smart phone 100 and the smart pad 200 are connected to each other.

In addition, the event controller 420 which operates in the application framework layer of the smart pad 200 performs the role of managing the events that occur in the smart pad 200 when the smart phone 100 and the smart pad 200 are connected to each other.

The lowermost layer is the Linux Kernel layer. Various drivers such as a display driver, a camera driver, and an audio driver are included in the Linux Kernel layer, and the Linux Kernel takes the role of an abstraction layer among the remaining layers of the hardware and the android platform stack.

Meanwhile, the Linux Kernel layer of the smart phone 100 includes a Phone Only Device Driver 441 which is a driver for the devices that exist only in the smart phone 100, and a same device driver 445 which is a driver for the devices that exist both in the smart phone 100 and the smart pad 200.

In addition, in the case where the smart phone 100 already knows a device list of the smart pad 200, the smart phone 100 generates a Virtual Pad Device Driver 450 regarding those devices, and the wrapper device driver 430 manages the interlocked operations of the smart phone 100 by supervising the same device driver 445 and the Virtual Pad Device Driver 450 together.

The reason for differentiating between the Phone Only Device Driver 441 and the same device driver 445, and generating the virtual pad device driver 450 and the wrapper device driver 430 is to utilize the data collected from the device of the smart pad 200, as aforementioned.

Meanwhile, data transmission/reception between the smart phone 100 and the smart pad 200 is made through a phone data TX/RX 460 and a PAD data TX/RX 470, which are the same concepts of the aforementioned phone communication unit 130 and the pad communication unit 230, respectively.

Hereinbefore the supposition was that the event machine 410 and the event controller 420 exist in the application framework layer, but that was merely for the convenience of explaining the present disclosure. Thus, the technical concept of the present disclosure would also apply to the cases where the event machine 410 and the event controller 420 exist in other layers of the upper layers of the Kernel layer not only in the framework layer. The present disclosure would also apply to the case where the event machine 410 and the event controller 420 exist in the Kernel layer as well.

Not only that, the aforementioned explanation on the layer of the event machine 410 and the event controller 420 is based on the assumption that the smart phone 100 or the smart pad 200 uses OS such as Linux Kernel, and thus if the smart phone 100 or the smart pad 200 operates on the basis of NON-OS such as by using a firmware, the event machine 410 and the event controller 420 would exist as one code within the firmware.

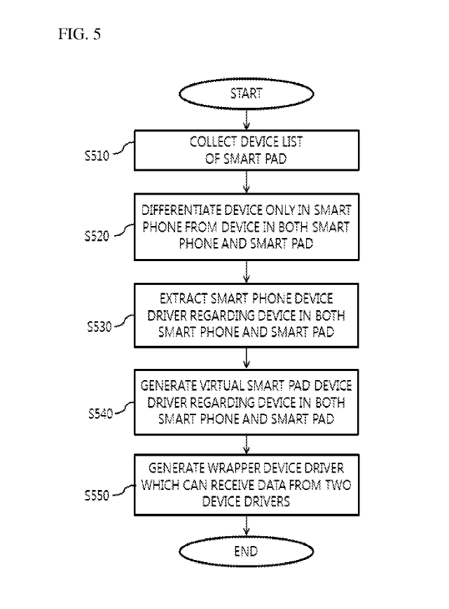

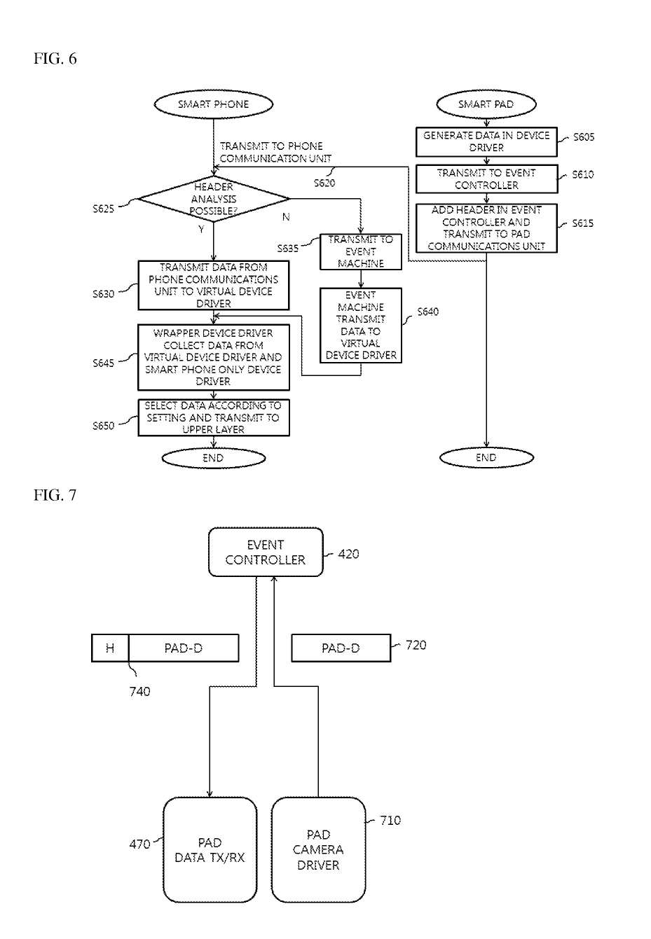

Referring to FIGS. 5 to 8, hereinafter is an explanation on a process for selectively utilizing the data collected from the smart phone 100 and the smart pad 200.

FIG. 5 is a flowchart provided for explaining a preparation process in the smart phone 100 for collecting data from the smart pad 200.

First of all, the smart phone 100 collects a device list of the smart pad 200 (S510). The device list refers to a list of devices provided in the smart pad 200. Generally, information on terminals which can be docked on with the smart phone 100 and information on devices provided in the terminals which can be docked on with the smart phone 100 is stored within the smart phone 100. Therefore, in the case where the smart phone 100 is docked on the smart pad 200, the smart phone 100 becomes able to collect the device list of the smart pad 200 based on such internal information.

Of course, in the case where a dummy terminal which can be docked on with the smart phone 100 is released on the market after the smart phone 100 is released on the market and thus there is no information on the dummy terminal nor the devices provided in the dummy terminal, when the smart phone 100 is docked on the dummy terminal, the smart phone 100 may be embodied to request the dummy terminal for related information.

Meanwhile, the smart phone 100 differentiates the devices that are provided in the smart phone 100 but are not provided in the smart pad 200 from the devices that are provided both in the smart phone 100 and the smart pad 200 (S520), extracts a smart phone 100 device driver regarding the devices that are both in the smart phone 100 and the smart pad 200 (S530), and manages the driver of the devices that are provided only in the smart phone 100 and the driver of the devices that are provided both in the smart phone 100 and the smart pad 200 separately. As aforementioned, a driver which is stored in the smart phone regarding the device that is provided both in the smart phone and the smart pad is referred to as the same device driver 445. Meanwhile, a driver which is stored in the smart phone regarding the device that is provided in the smart phone but not in the smart pad is referred to as the phone only device driver 441.

It is obvious that, of the above, the phone only device driver 441 is used to process the data collected from the devices that are provided only in the smart phone 100, while the same device driver 445 is used to process the data collected from the devices that are provided both in the smart phone 100 and the smart pad 200. However, the reason for managing these drivers separately is for the purpose of generating a virtual pad device driver 450 which processes data collected in the phone storage unit 140 within the smart phone 100 or the data collected from the smart pad 200.

That is, the smart phone 100 generates a virtual pad device driver 450 which is a copy of the same device driver 445 for processing the data collected from the smart pad 200.

As aforementioned, after generating the virtual pad device driver 450, the smart phone 100 generates a wrapper device driver 430 which can process all the data received from the same device driver 445 and the virtual devices driver 450 (S550).

That is, as aforementioned, the wrapper device driver 430 takes the role of transmitting the data collected from the same device driver 445, which is the data collected from the smart phone 100, and the data collected from the virtual pad device driver 450, which is the data collected from the smart pad 200, selectively to the application layer for processing.

Hereinafter explains the process of processing the data received from the smart pad 200, after the preparation on processing the data received from the smart pad 200 is completed.

FIG. 6 is a flowchart provided for explaining a selective data processing method according to an exemplary embodiment of the present disclosure.

First of all, the smart pad 200 generates data from the related device driver (S605). For example, in the case where the user commands to collect data from the camera module, the smart pad 200 generates image data from the device driver regarding the camera module.

Thereafter, the smart pad 200 transmits the generated data to the event controller 420 (S610). The event controller 420 exists in the application framework layer of the smart pad 200 to manage the interlocked operation when the two terminals are docked to each other, and the event controller 420 adds header information to the data received from the device driver and transmits the information to pad communication unit 230 of the smart pad 200 (S615). The header information includes information on which device the data is collected from, and information on which device driver the data should be processed by.

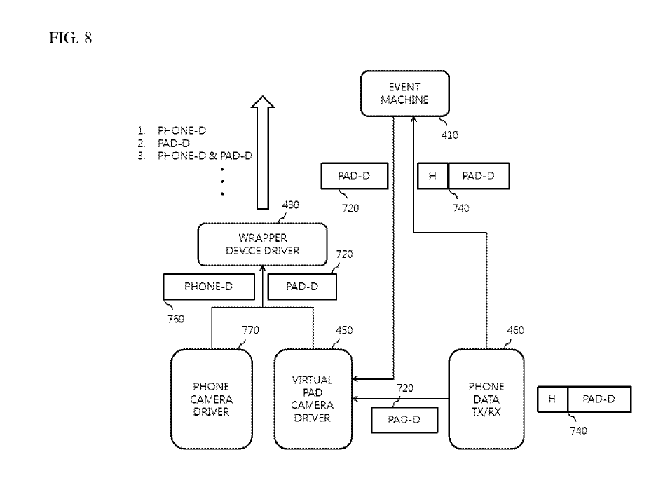

Hereinafter, explanation on the events that occur in the smart pad 200 will be made with reference to FIG. 7, which is a view provided to explain a pre-processing procedure of the data collected from the smart pad 200. FIG. 7 is based on the assumption that data is collected from a camera module.

Pad-side data 720 (hereinafter referred to as “PAD-D”) collected in a camera driver 710 of the smart pad 200 is transmitted to an event controller 420, and the event controller 420 transmits data where header is added to the PAD-D 720 (hereinafter referred to as “H|PAD-D”) to the pad communication unit 230.

Referring to FIG. 6 again, the pad communication unit 230 transmits the data to which the header information is added to the phone communication unit 130 (S620).

Meanwhile, hereinabove, the explanation was based on the assumption that the smart phone 100 and the smart pad 200 are connected to the HDMI interface and the USB interface, but it is a matter of course that the smart phone 100 and smart pad 200 can also be connected to interfaces other than the HDMI interface and the USB interface.

Not only that, even though the smart phone 100 and the smart pad 200 are physically connected to the HDMI interface and the USB interface, in the case of communications for data transmission, it will be also possible to proceed with a separate means other than the HDMI interface or the USB interface. For example, when two terminals are docked on each other, it may mean that they are in a quite close location to each other, so it will also be possible to transmit data using close wireless communication such as Bluetooth or Wifi.

Furthermore, the smart phone 100 and the smart pad 200 may be connected with MHL (Mobile High-definition Link) instead of the HDMI interface and USB interface. MHL is a type of interface which interconnects the smart phone 100 with another dummy terminal, enabling playing digital video/audio, thus having the advantage of transmitting data and supplying power.

The phone communication unit 130 of the smart phone 100 receives data where the header information is added (S620), and determines whether or not header analysis is possible (S625). In the case where header analysis is possible in itself (S625-Y), the phone communication unit 130 transmits the received data to the virtual pad device driver 450 according to the analyzed result (S630).

On the other hand, in the case where header analysis is not possible (S625-N), the phone communication unit 130 transmits the data where header information is added to the event machine 410 (S635). As aforementioned, the event machine 410 exists in the application framework layer of the smart phone 100, and takes the role of managing the events occurring in the smart phone 100 when the smart phone 100 is connected to the smart pad 200.

The event machine 410 analyzes the header information and transmits the data received according to the analyzed result to the processible virtual pad device driver 450 (S640). As aforementioned, the data received directly through the phone communication unit 130 and the data received through the event machine 410 is transmitted to the virtual pad device driver 450, and the data collected in the smart phone 100 in itself is transmitted to the smart phone's 100 phone device driver 440.

As aforementioned, the phone device driver 440 is differentiated as a phone only device driver 441 and a same device driver 445. In addition, the phone only device driver 441 is used to process data collected from the devices that are provided only in the smart phone 100, and the same device driver 445 is used to process data collected from the devices that are provided both in the smart phone 100 and the smart pad 200.

Meanwhile, the wrapper device driver 430 collects the data from the virtual pad device driver 450, together with the data from the same device driver 445 (S645), and selects the two data according to a predetermined setting such as the user's setting, and manufacturer's setting, and transmits the selected data to an upper layer (S650).

For better understanding of the events that occur in the smart phone 100, explanation will be made with reference to FIG. 8, which is a view provided to explain a procedure for processing the data received from the smart phone 100 and the smart pad 200. FIG. 8 is also based on the assumption that data is collected through a camera module, for unity with FIG. 7.

When H|PAD-D 740 is transmitted from the pad communication unit 230 to the phone communication unit 130, the phone communication unit 130 determines whether or not header analysis of such H|PAD-D 740 is possible, and if so, transmits the PAD-D 720 to the virtual pad camera driver 780. In addition, when header analysis of H|PAD-D 740 is not possible, the phone pad communication unit 230 transmits the H|PAD-D 740 to the event machine 410 so that header analysis can be done in the event machine 410.

The event machine 410 transmits the PAD-D 720 to the virtual pad camera driver 780 through header analysis.

Meanwhile, the camera driver 770 in the smart phone 100 transmits the data collected in itself 760 (hereinafter referred to as “PHONE-D”) to the wrapper device driver 790, and the virtual pad camera driver 780 transmits the PAD-D 720 to the wrapper device driver 790 as well.

Thereafter, the wrapper device driver 790 transmits data to the upper layer according to settings, that is, transmitting only the PHONE-D 760, or only the PAD-D 720, or both the PHONE-D 760 and the PAD-D 720, or at least one of the PHONE-D 760 and the PAD-D 720, to the upper layer.

By the aforementioned, even when the two terminals are docked on each other, it becomes able to selectively use the data collected in the devices of the two terminals, increasing efficiency of using the two terminals even in docked situation.

Meanwhile, hereinabove it was stated that data is selected by a predetermined method such as the user's setting, and the manufacturer's setting, and then transmitted to the upper layer, but such settings may be made differently according to different devices. For example, data collected from an illuminance sensor may be processed in average value and transmitted to the upper layer, and the data collected from an audio sensor may be processed in the sum of weighted values and then transmitted to the upper layer.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method for selectively processing data received from devices of a first terminal and devices of a second terminal, wherein the first terminal is docked on the second terminal, the method comprising:
generating, in the first terminal, a virtual driver regarding a device provided in the second terminal;
transmitting a first data generated from the device of the first terminal to a driver of the device provided in the first terminal which is the same as the device provided in the second terminal, of drivers of the devices provided in the first terminal;
receiving a second data generated from the device of the second terminal, and transmitting the received second data to the virtual driver; and
selecting at least one of the first data and the second data, transmitting the selected at least one of the first data and the second data to an upper layer of layers where the same driver and the virtual driver reside, and enabling the transmitted at least one of the first data and the second data to be processed.

2. The method as claimed in claim 1, further comprising:
generating a wrapper driver which receives the first data from the same driver, and receives the second data from the virtual driver, and
wherein the enabling the transmitted at least one of the first data and the second data to be processed is characterized that the wrapper driver transmits the at least one of the first data and the second data to the upper layer according to a setting, and enables the transmitted at least first data and the second data to be processed.

3. The method as claimed in claim 2, wherein the transmitting the received second data to the virtual driver is characterized that the second terminal adds header information per device to the second data and transmits the second data where the header information is added to the virtual driver, and
if the device according to the header information is differentiable in the second data received from the second terminal, the first terminal directly transmits the second data to the virtual driver;
but if the device according to the header information is not differentiable in the second data, the first terminal transmits the second data to the virtual driver via an event machine which manages events occurring when connecting the first terminal and the second terminal.

4. The method as claimed in claim 3, wherein the event machine is characterized to analyze the device where the second data can be processed, and transmits the second data to a virtual driver which corresponds to the analyzed device of the virtual drivers.

5. The method as claimed in claim 3, wherein the header information is characterized to comprise information on the device where the second data can be processed of the devices of the second terminal, and be added by an event controller which manages the events occurring when connecting the first terminal and the second terminal.

6. The method as claimed in claim 5, wherein the event controller and the event machine are characterized to reside in an upper layer of layers where the same driver and the virtual driver reside, if the first terminal and the second terminal operate based on OS; and exist in one code within the firmware, if the first terminal and the second terminal operate based on firmware.

7. The method as claimed in claim 2, wherein the setting is characterized to be different per device, and thus
one of the first data and the second data is transmitted to the upper layer, or an average of the first data and the second data is transmitted to the upper layer, or a sum of weighted values of the first data and the second data is transmitted to the upper layer.

8. The method as claimed in claim 1, wherein the first data and the second data is characterized to be received from the device driver of the first terminal and the device driver of the second terminal according to a service command of the upper layer.

9. A system for selectively processing data received from a device of a first terminal and a device of a second terminal, wherein the first terminal is docked on the second terminal,
wherein the system generates a virtual driver regarding a device provided in the second terminal, the system comprising:
a first terminal which transmits a first data generated from the device of the first terminal to a driver of the device provided in the first terminal which is the same as the device provided in the second terminal, of drivers of the devices provided in the first terminal, receiving a second data generated from the device of the second terminal and transmitting the received second data to the virtual driver, and selecting at least one of the first data and the second data, and transmitting the selected at least one of the first data and the second data to an upper layer of layers where the same driver and the virtual driver reside and enabling the transmitted at least one of the first data and the second data to be processed; and
a second terminal which generates a second data and transmits the generated second data to the first terminal.
